(19) United States
(12) Patent Application Publication
(10) Pub. No.: US 2014/0326202 A1
(43) Pub. Date: Nov. 6, 2014

(54) Six Stroke Internal Combustion Engine and a Method of Operation

(71) Applicant: Robert E. WAGNER, Butler, PA (US)

(72) Inventor: Robert E. WAGNER, Butler, PA (US)

(21) Appl. No.: 14/335,607

(22) Filed: Jul. 18, 2014

Related U.S. Application Data
(60) Provisional application No. 61/859,075, filed on Jul. 26, 2013.

(51) Int. Cl. F02B 75/02

(52) U.S. Cl. CPC F02B 75/021
USPC 123/64

(57) ABSTRACT

The present invention relates generally to an internal combustion engine and a method of operating the engine on a six stroke cycle, in which the fifth and sixth strokes cool the engine to improve efficiency and reduce emissions.

### CROSS REFERENCE TO RELATED APPLICATIONS

This application claims priority under 35 U.S.C. §119 to U.S. Patent Application No. 61/859,075, entitled INTERNAL COMBUSTION ENGINE HAVING INDEPENDENTLY CONTROLLED VALVES AND A METHOD OF OPERATION, filed Jul. 26, 2014, the disclosure of which is incorporated herein by reference in its entirety.

### BACKGROUND OF INVENTION

1. Field of Invention

The invention relates generally to an internal combustion engine. More specifically, the invention relates to an internal combustion engine operating on a six stroke cycle.

2. Description of Related Art

Internal combustion engines have typically operated on a 4 stroke cycle, comprised of intake, compression, combustion, and exhaust strokes. When the cycle repeats, the intake stroke directly follows the exhaust stroke in which the hot combustion gases are evacuated from the cylinder. The heat from the combustion gases raises the temperature of the cylinder wall, which in turn heats the air-fuel charge during the intake stroke. Excessive air intake temperature can lead to knocking. To prevent knocking, the compression ratio of a typical engine is limited to the range of 8 to 11, which also limits the efficiency of the engine.

Six stroke cycle engines have previously been disclosed that cool the cylinder and use the excess heat created by combustion to improve the operating efficiency of the engine. In U.S. Pat. No. 8,291,872 to Szybist, water is injected into the cylinder during the fourth stroke, when the combustion gases are typically exhausted. The water, which is heated by the combustion gases, is turned to steam and provides additional power during a fifth stroke. The sixth stroke exhausts the steam and combustion gases from the cylinder. Similarly, in U.S. Pat. No. 6,311,651 to Singh, water is injected during the fourth stroke of a six stroke cycle engine to improve engine efficiency, wherein the amount of water to be injected is calculated by determining the energy content of the cylinder.

The previous examples of six stroke cycle engines have relied on complicated water injection systems to improve overall engine efficiency. The invention of the present disclosure overcomes this problem by cooling the cylinder during fifth and sixth strokes without the need for water injection.

### BRIEF SUMMARY OF INVENTION

The present invention relates generally to a six stroke cycle internal combustion engine. The first stroke is an intake stroke, in which fuel and air are drawn into the cylinder. During the second stroke, the contents of the cylinder are compressed. The third stroke is the combustion stroke where the air/fuel mixture is ignited. The fourth stroke exhausts the contents of the cylinder. The first four strokes are similar to those of a typical four stroke cycle engine. However, during a fifth stroke, air is drawn through an open intake valve. During this stroke, the fresh air absorbs heat from the piston and cylinder. In the sixth and final stroke, the heated air is expelled through an open exhaust valve. As the six stroke cycle repeats, the temperature of the cylinder is reduced compared to if the cycle repeated after the fourth stroke as in a typical four stroke cycle.

The opening and closing of the valves can be accomplished through mechanical or electrical means. Typical internal combustion engines use cams, pushrods, or rocker arms to accomplish this task. In a four cycle engine, each valve is being opened only once during each cycle. Thus, the cam has only one lobe and rotates once per engine cycle. In the six stroke cycle engine of the present invention, the valves open twice per cycle. To accomplish this, the cam has two lobes. The same result can be accomplished by attaching a solenoid to the valve stem. In this configuration, a controller determines when to open and close each valve.

### BRIEF DESCRIPTION OF THE SEVERAL VIEWS OF DRAWINGS

FIGS. 1-7 depict a cylinder of an internal combustion engine during each of six strokes according to an embodiment of the present invention, with a legend identifying the gases and fuel present in the engine.

FIG. 8 depicts a cylinder of an internal combustion engine with independently controlled intake and exhaust valves.

### DETAILED DESCRIPTION OF THE INVENTION

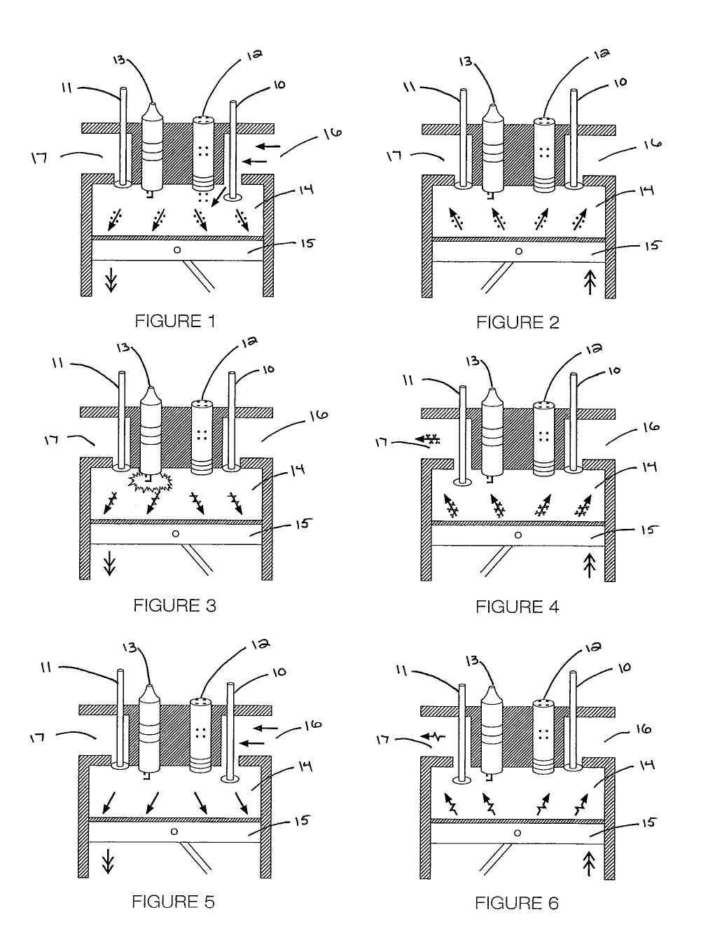

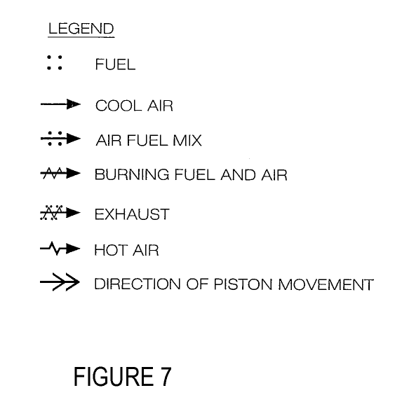

In the preferred embodiment of the present invention, an internal combustion engine completes a six stroke cycle. The first four strokes are similar to that of a typical four stroke cycle engine. As shown in FIG. 1, the first stroke is an intake stroke. During this stroke, intake valve 10 is in an open position. Fresh air from the air intake 16 is drawn into the cylinder as piston 15 moves away from the valves 10 and 11. Also, the fuel injector 12 injects fuel into the cylinder 14 during this stroke. In FIG. 2, the air/fuel mixture is compressed as the piston 15 moves in the opposite direction, towards valves 10 and 11. FIG. 3 shows the combustion stroke, where spark plug 13 ignites the compressed air/fuel mixture. The combustion of the air/fuel mixture forces the piston 15 away from the top of the cylinder 14. During the second and third strokes, both the intake valve 10 and the exhaust valve 11 remain closed. In the fourth stroke, as shown in FIG. 4, the exhaust valve 11 opens and the combustion gases are expelled through the exhaust 17.

FIG. 5 depicts the fifth stroke in which the intake valve 10 is in the open position and fresh air is drawn into the cylinder 14 as the piston 15 moves toward the bottom of the cylinder 14. In a typical four stroke cycle engine, the next stroke after the exhaust stroke would be a new intake stroke in which both fuel and air would be drawn into the cylinder. However, in the preferred embodiment of the present invention, only air is drawn into the cylinder 14 during this stroke. This fresh air, which is close to the ambient air temperature surrounding the engine, is heated by the walls of the cylinder 14 and piston 15, causing a decrease in the temperature of those components.

FIG. 6 shows the sixth and final stroke. In this stroke, the intake valve 10 is in a closed position and the exhaust valve 11 is in an open position. As the piston 15 moves towards the valves 10 and 11, the fresh and heated air is forced out of the cylinder 14 through the exhaust 17. Consequently, the temperature of the cylinder 14, piston 15, and other components defining the combustion chamber is lower than it was after the fourth stroke. When the cycle repeats, the air/fuel mixture drawn into the cylinder 14 will be heated to a lesser extent than without the fifth and sixth strokes. With a cooler air charge, the compression ratio of the engine can be increased to increase the overall efficiency of the engine. Other engine operation parameters can be adjusted as well to take advantage of the decreased air and fuel mixture temperature.

By exhausting fresh air into the exhaust 17, unburnt fuel will have the opportunity to complete combustion. In addition, most modern car engines require an exhaust gas recirculation (EGR) system. The EGR system is designed to reduce the nitrous oxide emissions that are created at high temperatures in the exhaust 17. In an EGR system, a portion of the exhaust gas is recirculated into the intake of the engine to displace combustible air. This has the effect of reducing combustion chamber temperatures. However, while reducing emissions, the EGR system further has the effect of reducing peak power output of the engine. The fifth and sixth strokes of the present invention cause a reduction in the temperature of the exhaust without the need for an EGR system.

A person having skill in the art will appreciate that various configurations of the engine components can be used in a six stroke cycle. For example, two valves or four valves can be used in the same manner as described in this disclosure. Moreover, the figures depict a cylinder 14 having direct injection, where the fuel injector 12 puts fuel directly into the cylinder 14. The fuel injection 12 can alternatively be placed in the intake 16 to each cylinder. Also, the internal combustion engine of the present invention can run on gasoline, diesel, natural gas, or other fuels that have been used in traditional four stroke internal combustion engines.

To allow the intake 10 and exhaust 11 valves to open twice per cycle, a cam is provided with two lobes. In a typical four stroke cycle engine, the cam has only one lobe. Because the cam completes one rotation per cycle, the cam in the six stroke cycle engine of the present invention rotates 60 degrees per stroke. Referring to the figures, the intake valve 10 is open during the intake stroke, as shown in FIG. 1. This open condition corresponds with a lobe of the cam contacting the valve stem or rocker arm, depending on the configuration of the engine. As the cam rotates 60 degrees during the next stroke, the lobe disengages and the intake valve 10 moves to the closed position. As the engine moves through the third and fourth strokes, the intake valve 10 remains closed and the cam has rotated an additional 120 degrees. In the fifth stroke, the cam rotates another 60 degrees and the second lobe of the cam engages the valve stem and the intake valve 10 moves to the open position, as shown in FIG. 5. The intake valve 10 moves to the closed position as the cam rotates during the sixth stroke. Since the valve is open during the first and fifth strokes, the two lobes on the cam are correspondingly located at the zero degree and 240 degree positions. The cam for the exhaust valve works in the same manner, but the lobes are located at the 180 degree and 300 degree positions since the exhaust valve 11 is in the open position at during the fourth and sixth strokes.

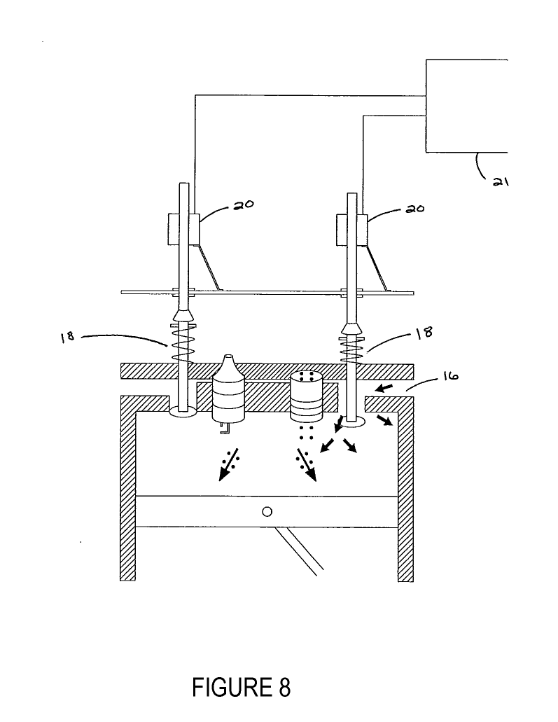

In the alternative embodiment of the present invention, electronically controlled solenoids 20 are used as the actuation mechanism for the intake 10 and exhaust valves 11 of the engine. Each intake 10 and exhaust valve 11 has separate solenoids 20 so that the valve timing in each cylinder 14 can be controlled independent of other cylinders or engine rotation. The valve will be held in a normally closed position by a valve spring 18, as shown in FIG. 8. When an electrical signal is sent to the solenoid 20 by a controller 21, the solenoid 20 depresses the valve, causing it the move to the open position.

In one embodiment of the present invention, the controller 21 is further electronically connected to sensors providing information such as throttle position, intake air temperature, and engine speed, among others. In other embodiments of the present invention, the controller 21 is part of the engine control unit. The controller 21 has the ability to vary the sequence of opening and closing of the valves 10 and 11 based on the needs of the engine.

The controller 21 further has the ability to control the duration of the time a valve is opened. For example, if a cylinder is running rich, the duration that the intake valve 10 is open can be decreased to limit the amount of fuel entering the cylinder for a port injected engine, similar to a choke operation on a carbureted engine. The timing of the valves can eliminate rich conditions that result in backfires and high carbon emissions. When undesired air/fuel mixtures are eliminated, fuel efficiency will be improved and the engine will have improved response to load changes.

With independent control of the valves and fuel delivery, the operation of the engine can be varied depending on engine load, engine conditions, sensor input, or external conditions. For example, in cold conditions, the engine can operate as a standard four stroke cycle engine until the cylinder 14 reach a temperature that requires further cooling. As another example, during highway cruising in which a relatively light load is placed on the engine, individual cylinders can have fuel cut-off and the valves 10 and 11 opened to reduce pumping losses, reducing the effective displacement of the engine. In this method of operation, in which certain cylinders are not receiving fuel, fuel economy can be increased.

The invention claimed is:

1. A internal combustion engine capable of operating on a six stroke cycle, the engine comprising:
exhaust valves;
intake valves;
actuation means connected to the valves, wherein the valves are actuated twice per cycle.

2. The engine of claim 1 wherein the actuation means is comprised of:
a solenoid in contact with each of the exhaust valve and the intake valve; and
a controller capable of sending a signal to the solenoid.

3. The engine of claim 1 wherein the actuation means is comprised of:
a cam in contract with each of the exhaust valve and the intake valve, wherein the cam has two lobes.

4. A method of operating an internal combustion engine having a cylinder, a piston, an intake valve, and an exhaust valve to provide a six stroke cycle, the method comprising:
performing a first stroke in which a piston travels away from an intake valve in an open position and an exhaust valve in a closed position, drawing air into the cylinder, and in which fuel is introduced into a cylinder;
performing a second stroke in which a piston travels towards the intake valve which is in a closed position and the exhaust valve which is in the closed position, compressing the contents of the cylinder;
performing a third stroke in which the fuel is ignited forcing the piston away from the closed intake valve and the closed exhaust valve;
performing a fourth stroke in which the piston travels towards the intake valve which is in the closed position and the exhaust valve which is in the open position, forcing the contents of the cylinder out of the cylinder;
performing a fifth stroke in which the piston travels away from the intake valve which is in the open position and the exhaust valve which is in the closed position, drawing air into the cylinder; and
performing a sixth stroke in which the piston travels towards the intake valve which is in the closed position and the exhaust valve which is in the open position, forcing the contents of the cylinder out of the cylinder.
